(19) United States
(12) Patent Application Publication
(10) Pub. No.: US 2021/0227841 A1
(43) Pub. Date: Jul. 29, 2021

(54) SMOKER DEVICE

(71) Applicant: The Dickey Smoker, LLC, Austin, TX (US)

(72) Inventor: Victor J. Crosswell, Austin, TX (US)

(73) Assignee: The Dickey Smoker, LLC, Austin, TX (US)

(21) Appl. No.: 16/775,255

(22) Filed: Jan. 28, 2020

(51) Int. Cl. A23B 4/052; A47J 37/07

(52) U.S. Cl. CPC A23B 4/052; A23V 2002/00; A47J 37/0786

(57) ABSTRACT

A smoker accessory for charcoal and gas grills for burning wood pellets comprises an elongate tubular body having a plurality of openings formed therethrough for induction of combustion air and venting of smoke. A solid elongate tubular neck connects to the body and terminates in an open mouth. The diameter of the mouth is less than the diameter of the body thereby helping to contain pellets and ash when the smoker is positioned along a horizontal axis during use.

### TECHNICAL FIELD

The present disclosure relates generally to apparatus, accruement, accessories, and methods of manufacture therefor, for use with gas and charcoal grills, barbeque pits, electric smokers, and the like. Particularly, the present disclosure relates to wood smokers that consume wood pellets or chips used for imparting smoke flavoring to food during grilling or cold smoking, and more particularly still, those for use in conventional charcoal, propane or natural gas fired outdoor grills.

### BACKGROUND

One way of preparing meats, fish, cheeses, and other foods is to immerse the food in dense smoke from combustion or smoldering of select woods such as apple, hickory, pecan, or mesquite. Over time, the smoke permeates, tenderizes, and imbibes the food with delicious smokey flavor. This smoking process may be performed cold, for cheeses and the like, or under low heat for slow cooking meats.

The most effective means for smoking uses a large dedicated log-burning smoker barbeque pit, in which wood is burned in a chamber offset and removed from the cooking surfaces and billowing smoke flows across the food on its exit from the pit. However, due to the size and expense of these types of smokers, use is limited to commercial enterprises and the most dedicated of smoker enthusiasts.

Other, smaller, smoker appliances are commercially available that employ wood pellets and are typically electrically powered or propane-fired. These appliances, however, still consume valuable space and may be cost prohibitive for many typical weekend outdoor chefs, who smoke foods only occasionally. Rather, these dedicated smoker appliances find a market for hobbyists who, for cost or space concerns, a log-burning pit is not practical. Moreover, they can produce inconsistent smoking results, be difficult to assemble, temperamental to operate, and prone to failure after a short time.

Although large barbeque pits and dedicated smoker appliances may not be suitable for most weekend outdoor chefs, charcoal or gas grills are indeed prolific and an icon of American lifestyle. Typical grills are less than optimal for smoking foods, not having volume controls for induction of combustion air or venting nor dedicated heating means for combustion of wood apart from cooking food. Nevertheless, a number of grill accessories exist for generating wood smoke from wood chips, pellets or sawdust. These accessories are necessarily compromises, with limitations of effectiveness, burn time, space and heat required, and ease of use.

One class of grill accessory has a wood combustion chamber that must be mounted to the outside of the grill. Smoke is ported to the inside of the grill. Typically, no dedicated heat source is provided to initiate or continue combustion. A drawback of such a device is that grill must be permanently modified to install the device, which may be difficult and time consuming.

Other grill smoker accessories are placed entirely within the grill, either on the cooking grates or below the grates closer to the heat source. These may include cast iron or steel boxes with removable and vented lids. In use, the box must be preheated on a hot grill. Wood chips are placed into the open hot box on the grill and arranged with tongs. The box is left uncovered until the wood chips ignite. Once ignited, box is covered, extinguishing the flames and causing the chips to smolder and emit smoke. The box structure helps to contain wood material and ash, but smoker boxes are considered by many to be difficult to use. The heat source may not be sufficiently hot causing difficulty in igniting the wood chips or failing to maintain the chips in a smoldering state, or the heat source may be too hot, causing the chips to burn rapidly rather than smolder, limiting the smoke output and smoke time. Moreover, the boxes take up valuable space on the cooking grill, yet have a fairly limited smoke time. The must be filled, ignited, covered, uncovered, refilled, reignited, and recovered, many times over if a longer smoke is required, all over a hot grill. This tedious process is uncomfortable for the user and may subject the user to burns.

Another grill smoker accessory employs an elongate tubular mesh-like container, closed at one end and open at the other. To operate, the container is placed upright, with the open mouth positioned upward. The container is partially filled with smaller wood pellets, which are packed in place by tamping. The upper layer of the pellets is lit using a butane or propane torch. One lit, the flames are manually blown out, and the smoker is carefully laid on its side in the grill, either under or on top of the cooking grate. The smaller pellets, packed in place, tend to smolder more reliably than the wood chips in a smoker box, making the tubular smoker less temperamental than the box-type smoker. Accordingly, they are better suited for cold smoking and may also be used with dedicated smoking appliances to augment or enhance smoking. They are available in various lengths to suit various required smoking times, and they typically take up less space on the grilling surface than smoker boxes. However, care must be taken when placed in the grill to prevent ash from blowing and contaminating food and soiling the grill and to prevent unpacking and spillage of the pellets when the tube is laid on its side.

### BRIEF DESCRIPTION OF THE DRAWINGS

Embodiments are described in detail hereinafter with reference to the accompanying figures, in which:

FIG. 1 is a perspective view of a smoker for use with grills according to one or more embodiments, showing an elongate tubular body with a plurality of openings formed therethrough and an open mouth having a smaller diameter than that of the body;

FIG. 2 is an elevation view of the front of the smoker of FIG. 1;

FIG. 3 is an elevation view of the right side of the smoker of FIG. 1;

FIG. 4 is an elevation view of the back of the smoker of FIG. 1;

FIG. 5 is an elevation view of the left side of the smoker of FIG. 1;

FIG. 6 is a plan view of the top end of the smoker of FIG. 1, showing the reduced diameter mouth; and

FIG. 7 is a plan view of the bottom end of the smoker of FIG. 1.

### DETAILED DESCRIPTION

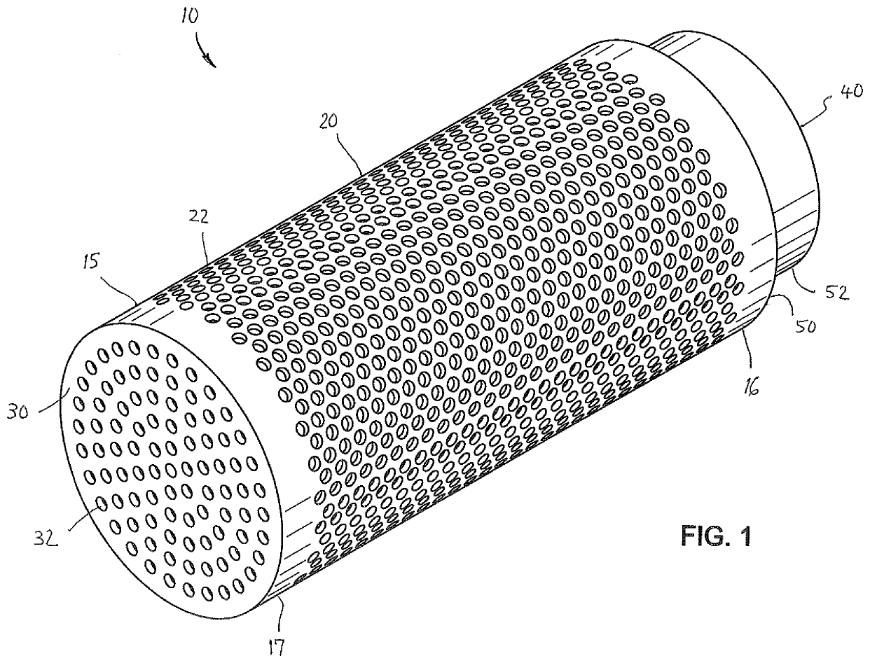

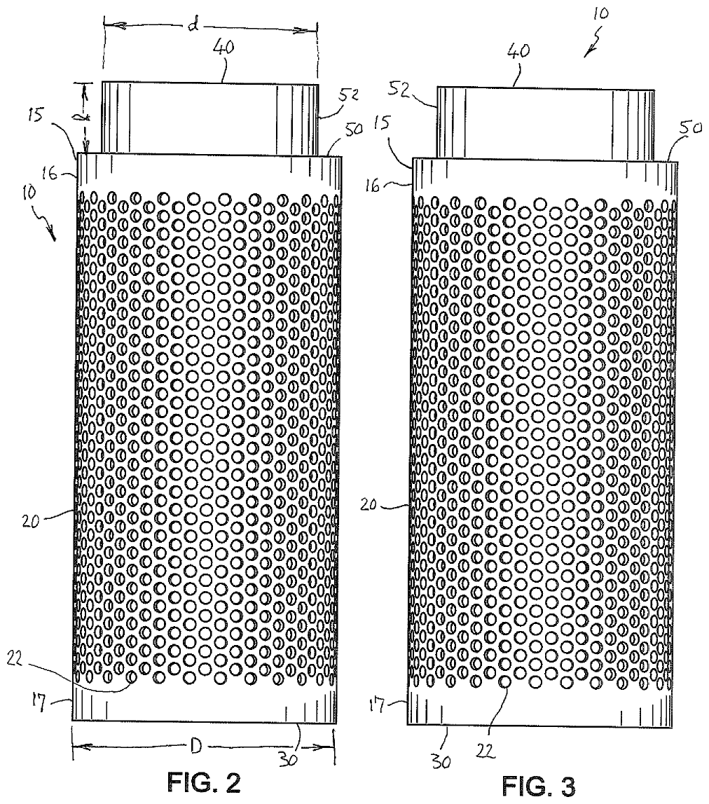

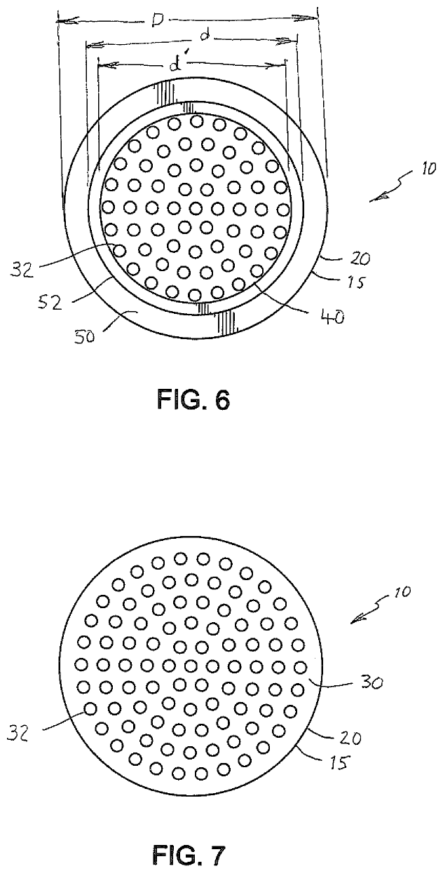

FIG. 1 is a perspective view of a smoker device 10 according to one or more embodiments. FIGS. 2-5 are elevation views of the front, right side, back, and left side, respectively, of smoker device 10. FIGS. 6 and 7 are plan views of the top end and the bottom end of smoker device 10, respectively. Referring to FIGS. 1-7, smoker device 10 ideally has a tubular body 15 defining a cylindrical wall 20, a closed planar base 30 at the bottom end, and an open mouth 40 at the top end.

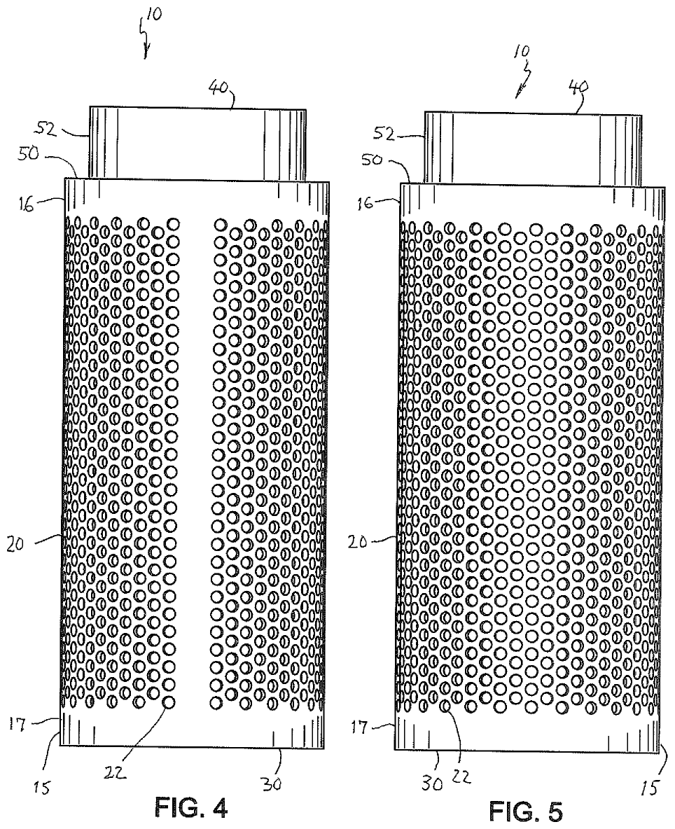

Wall 20 has a plurality of openings 22 formed therethrough in a manner so as to create a screen- or mesh-like structure. Ideally, openings 22 are formed substantially along the longitudinal length of body 15. Regions 16 and 17 near the top and bottom ends of body 15 may be devoid of openings 22 to promote rigidity and strength and/or to facilitate manufacture. Similarly, openings 22 are formed substantially about 360 degrees about the circumference of body 15. As shown in FIG. 4, one or more longitudinal regions 18 may be also be devoid of openings 22 to promote rigidity and/or to facilitate manufacture.

As with wall 20, base 30 includes a number of openings 32 formed therethrough. The dimensions of openings 22, 32 are small enough as to prevent typical commercially-available wood pellets from passing therethrough. Ideally, the dimensions of openings 22, 32 are such as to minimize ash resulting from combustion of wood pellets to easily pass therethrough. Although openings 22, 32 are illustrated as being circular, other opening shapes may be used as appropriate. The overall combined open area of wall 20 resulting from openings 22 and of base 30 resulting from openings 32 is sufficient to provide intake air for combustion or smoldering and venting of resultant smoke.

As shown most clearly in FIGS. 2 and 6, open mouth 40 at the top end of smoker device 10 has a smaller diameter d′ than the diameter D of body 15. In one or more embodiments, upper region 16 defines a continuous, or solid, circular shoulder 50 circumvolving cylindrical wall 20. Shoulder 50 may be normal to wall 20 and parallel with base 30, as illustrated, or it may tapered at a non-perpendicular angle. The inner circumference of shoulder 50 adjoins a neck 52, which may be elongate and has an axial length l. Neck 52 is solid, meaning that it has no holes or openings formed therethrough like wall 20 or base 30. The outer diameter d of neck 52 is less than the outer diameter D of body 15. The diameter d′ of open mouth 40, outer diameter d of neck 52, and the axial length l of neck 52 are selected so as to substantially minimize the chances of spillage of wood pellets from mouth 40 when smoker is laid on its side and spillage of ash from mouth 40 when smoker 40 is removed from the grill. Neck 52 may be cylindrical, as illustrated, or it may be frustoconical, tapering to a smaller diameter at mouth 40. In such a case, a frustoconical neck 52 may but need not directly adjoin wall 20 without shoulder 50.

Although a cylindrical smoker device 10 is shown and described, other tubular shapes may also be used within the scope of the disclosure, such as square, hexagonal, oval, and the like. In this case, neck 52 may still be cylindrical or frustoconical, or it may have a profile that matches the shape of body 15. Similarly, mouth 40 may be circular or have a shape that matches the shape of body 15. Regardless, the dimensions of mouth 40 and neck 52 are smaller than the corresponding dimensions of body 15.

In another embodiment, the entire body 15 may be tapered. That is, a longitudinal line taken along wall 20 may not lie parallel with the axis of smoker device 10. For instance, a frustoconical or pyramid-shaped body 15 having a gentle taper resulting a smaller mouth 40 than base 30 may be used as appropriate.

The axial length of body 15 may vary, depending on the smoke time desired. For example, the body length may range between 4 and 16 inches which allows for convenient use in most grills.

In one or more embodiments, body is between 5 and 12 inches, which provides an optimal burn time and small size.

Similarly, the diameter D of body 15 may also be varied to provide an adequate smoke time. For example, a body outer diameter D between 1.5 and 3.5 inches may be used. In order to prevent spillage of pellets, the outer diameter d of neck 52 is ideally about eighty percent of, and more preferably still, at least 0.5 inch smaller than, the outer diameter D of body 15. Similarly, the diameter d′ of mouth 40 is preferably about seventy percent of, and more preferably still, at least 0.75 inch smaller than, the outer diameter D of body 15. These dimensions, of course, depend slightly on the thickness of wall 20, and are generally suitable for steel walls 20 falling in the range of 12 to 18 gauge. Likewise, the axial length l of neck 52 in order to avoid spillage of pellets depends largely on the diameter D of body 15 and the diameter d′ of mouth 40, and to a lesser extent on the axial length of body 15. Ideally, length l of neck 52 is at least equal to the difference of D minus d′. For instance, a smoker device 10 having a six-inch long body 15 of diameter D=2.75 inches would ideally have a mouth 40 of diameter d′=2.0 inches and a neck 52 of length l of 0.75 inches.

In one or more embodiments, smoker device 10 may be formed of a metal, such as aluminum or stainless steel according to any known and suitable manufacturing technique. Solid axial region 18 allows wall 20 to be stamped from a flat sheet, rolled and welded along a longitudinal seam in one manufacturing technique. Similarly, solid region 16 allows wall 20 to be welded to shoulder 50 or neck 52, and solid region 17 allows wall 20 to be welded to base 30. Techniques that allow manufacture of smoker device 10 without welding are also known in the art.

In operation, smoker device 10 may be initially placed upright, with mouth 40 positioned upward. Smoker device 10 is then partially filled with wood pellets, which may be presoaked in water and are packed in place by tamping. The upper layer of the pellets is lit using a butane or propane torch. One lit, the flames are manually blown out, and smoker device 10 may be carefully laid on its side in the grill, either under or on top of the cooking grate. However, depending on the dimensions of smoker device 10 and the grill in which it is employed, smoker device 10 may also be used in a vertical orientation. As with a chimney, using smoker device 10 vertically acts to draw smoke more efficiently, expelling wood smoke consistently throughout the grilling chamber for more effective smoking of food.

Terms of orientation, such as top, bottom, front, back, left, and right, are used herein to aid the reader in understanding the disclosure. These terms are not intended to be limiting, and the described orientation of smoker device 10 may be changed without limiting the scope of the disclosure.

The Abstract of the disclosure is solely for providing the a way by which to determine quickly from a cursory reading the nature and gist of technical disclosure, and it represents solely one or more embodiments.

While various embodiments have been illustrated in detail, the disclosure is not limited to the embodiments shown. Modifications and adaptations of the above embodiments may occur to those skilled in the art. Such modifications and adaptations are in the spirit and scope of the invention.

What is claimed:

1. A smoker device (10) comprising:
an elongate tubular body (15) including a wall (20) disposed between first and second ends and defining a body diameter (D);
a closed base (30) disposed at said second end and adjoined to said wall;
a solid elongate tubular neck (52) coupled to said wall at said first end and defining a neck diameter (d) that is less than said body diameter, a distal end of said neck defining an open mouth (40); and
a first plurality of openings (22) formed through said wall.

2. The smoker device of claim 1 further comprising:
a second plurality of openings (32) formed through said base.

3. The smoker device of claim 1 wherein:
said base is planar.

4. The smoker device of claim 3 further comprising:
a solid shoulder (50) coupled between said wall and said neck.

5. The smoker device of claim 4 wherein:
said shoulder is parallel to said base.

6. The smoker device of claim 1 wherein:
said body is cylindrical.

7. The smoker device of claim 1 wherein:
said neck is cylindrical.

8. The smoker device of claim 1 wherein:
said neck is frustoconical.

9. The smoker device of claim 1 wherein:
said mouth defines a mouth diameter (d′) that falls within the range of 60 to 90 percent the of body diameter.

10. The smoker device of claim 1 wherein:
said mouth defines a mouth diameter (d′) that is between 0.5 and 1.0 inches smaller than the body diameter.

11. The smoker device of claim 1 wherein:
said neck diameter falls within the range of 70 to 90 percent of the body diameter.

13. The smoker device of claim 1 wherein:
said neck diameter is between 0.0 and 0.75 inches smaller than the body diameter.

14. The smoker device of claim 1 wherein:
said body diameter falls within the range of 1.5 to 3.5 inches.

15. The smoker device of claim 1 wherein:
said mouth defines a mouth diameter (d′); and
said neck defines an axial length (l) that is at least as long as the body diameter less the mouth diameter.
